(19) United States
(12) Patent Application Publication
(10) Pub. No.: US 2021/0080769 A1
(43) Pub. Date: Mar. 18, 2021

(54) DISPLAY DEVICE

(71) Applicant: SHENZHEN CHINA STAR OPTOELECTRONICS TECHNOLOGY CO., LTD., Shenzhen, Guangdong (CN)

(72) Inventors: Xinbin TIAN, Shenzhen, Guangdong (CN); Xiangyang XU, Shenzhen, Guangdong (CN); Mengmeng ZHANG, Shenzhen, Guangdong (CN)

(21) Appl. No.: 16/079,471

(22) PCT Filed: Jun. 25, 2018
(86) PCT No.: PCT/CN2018/092593

§ 371 Date: Aug. 23, 2018

(30) Foreign Application Priority Data
Apr. 19, 2018 (CN) 201810353918.2

(51) Int. Cl. G02F 1/1333; G02F 1/13357; G02F 1/1335

(52) U.S. Cl. CPC G02F 1/13336; G02F 1/133528; G02F 1/133602

(57) ABSTRACT

A display device is provided comprising a plurality of display panels, each of which includes a display area and an edge area disposed on the periphery of the display area; any two adjacent display panels being lapped to form a lapping region, wherein the edge area of one display panel is lapped to the display area of the other display panel in the lapping region, and the edge area of one display panel is projected on the side of the edge area of the other display panel; each of the edge areas is light transmissive to allow light to illuminate the display area through the edge area. The present disclosure can achieve seamless display of the display screen of lapped display panels.

### RELATED APPLICATION

The present application claims priority to Chinese Patent Application No. 201810353918.2, entitled display device, filed on Apr. 19, 2018, the disclosure of which is incorporated herein by reference.

### FIELD OF THE INVENTION

The present disclosure relates to a display field, in particular to a display device.

### BACKGROUND OF THE INVENTION

The existing display panel, especially the liquid crystal display panel, has a driving device, a large number of metal wires, and a wide sealant area, and the like in its frame. Therefore, after a plurality of display panels are lapped, it is difficult to achieve seamless display of the display screen for the lapped display panel, and the boundary of the lapped display panel is particularly obvious especially when viewed at a close distance. There is no effective way to achieve seamless display of the display screen for the lapped display panels at present.

### SUMMARY OF THE INVENTION

The object of the present disclosure is to provide a display device to achieve seamless display of display screen for lapped display panels.

The present disclosure provides a display device comprising a plurality of display panels, each of which includes a display area and an edge area disposed on the periphery of the display area;

any two adjacent display panels being lapped to form a lapping region, wherein the edge area of one display panel is lapped to the display area of the other display panel in the lapping region, and the edge area of one display panel is projected on the side of the edge area of the other display panel;

each of the edge areas is light transmissive to allow light to illuminate the display area through the edge area.

The edge area disclosed herein is provided with metal wires and a driving device, and a light-transmitting region used for light transmission is disposed between the metal wires, and between the metal wires and the driving device.

The width of the light-transmitting region disclosed herein is between four-fifths to six-fifths of the width of the metal wire.

The display device disclosed herein comprises a fixing portion for fixing opposite surfaces of the two display panels in the lapping region.

The edge areas of the two display panels in the lapping region have the same width.

The width of the lapping region disclosed herein is equal to the sum of the width of the two edge areas located in the lapping region.

The width of the lapping region disclosed herein is greater than the sum of the width of the two edge areas located in the lapping region.

The display device disclosed herein comprises an anti-reflection film disposed on an edge area of the display panel.

One of the display panels disclosed herein is lapped with two display panels in edge areas on the same surface, and each of the remaining display panels is lapped with two display panels in edge areas on two opposite surfaces; the remaining display panels are ones out of a plurality of the display panels except for the one which is lapped with two display panels in edge areas on the same surface.

The fixing portion disclosed herein comprises a glue layer for bonding opposite surfaces of the two display panels in the lapping region.

In summary, the edge area in the lapping region of the present disclosure is light transmissive to allow light to illuminate the display area through the edge area. Therefore, light that illuminates the display area in the lapping region is less affected by the edge area when the two display panels are overlapped, since the edge area has less influence on light. The seamless display may be achieved for the display device formed by the lapping of display panels, and the display device does not have obvious border boundary when viewed at a close distance.

### BRIEF DESCRIPTION OF THE DRAWINGS

In order to illustrate implementations of present disclosure or the technical solutions of other implementations more clearly, the drawings according to the implementations of present disclosure or the drawings according to the other implementations will be introduced briefly. Apparently, hereinafter described drawings are merely a portion of implementations of present disclosure. For those skilled in the art, they can obtain other drawings on the base of these drawings without creative work.

FIG. 1 is a schematic sectional view of a flat display device provided by an implementation of the present disclosure.

FIG. 2 is a first schematic sectional view of the lapping region of FIG. 1.

FIG. 3 is a second schematic sectional view of the lapping region of FIG. 1.

FIG. 4 is a schematic sectional view illustrating a backlight module mounted in the display device shown in FIG. 1.

FIG. 5 is a schematic sectional view of a curved display device provided by an implementation of the present disclosure.

### DETAILED DESCRIPTION OF THE INVENTION

Hereinafter, a clear and complete description of the technical solutions in the implementations of the present disclosure will be illustrated, which combined with the drawings in the implementations of the present disclosure. Apparently, described implementations are merely a portion of implementations of present disclosure, rather than all of the implementations. Base on the implementations of present disclosure, all other implementations obtained by those skilled in the art without creative work are considered to be encompassed within the scope of the present disclosure.

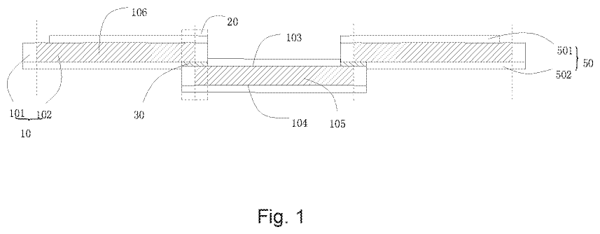

See FIG. 1. The present disclosure provides a display device comprising a plurality of display panels 10, wherein each of display panels 10 includes display area 101 and edge area 103 disposed on the periphery of display area 101; any two adjacent display panels 10 are lapped to form lapping region 20; edge area 102 of one display panel 10 in the lapping region 20 is lapped to display area 101 of the other display panel 10, and edge area 102 of one display panel 10 is projected on the side of edge area 102 of the other display panel 10; each of edge areas 102 is light transmissive to allow light to illuminate display area 101 through edge area 102.

Edge area 102 in lapping region 20 of the present disclosure is light transmissive to allow light to illuminate display area 101 through edge area 102. Therefore, light that illuminates display area 102 in lapping region 20 is less affected by edge area 102 when the two display panels 10 are overlapped, since edge area 102 has less influence on light. The seamless display may be achieved for the display device formed by the lapping of display panels 10, and the display device does not have obvious border boundary when viewed at a close distance.

Specifically, edge area 102 is provided with metal wires and a driving device, and a light-transmitting region used for light transmission is disposed between the metal wires, and between the metal wires and the driving device. In the common design of a display panel, since edge area 102 of display panel 10 is provided with a driving device and metal wires, and the distance between the metal wires, and the distance between the metal wires and the driving device is small, and edge area 102 is provided with a black matrix, light cannot pass through edge area 102 when light reaches edge area 102 after the display panels are lapped. In the present disclosure, by widening edge area 102 to disperse the driving device and the metal wires disposed on edge area 102 in a larger area, and cancelling the black matrix of edge area 102, a light-transmitting region is created between the driving device and the metal wires disposed on edge area 102, and light may illuminate display area 101 through the light-transmitting region. When the driving device and the metal wires are rearranged, the light-transmitting region may be disposed as a uniform light-transmitting region, so that light passing through the light-transmitting region of edge area 102 is relatively uniform light, and the light transmittance of the light is higher, by which the seamless display of the display device formed by the lapping of display panels 10 can be realized, and the display device does not have obvious border boundary when viewed at a close distance.

In this implementation, the width of the light-transmitting region is between four-fifths to six-fifths of the width of the metal wire. Specifically, in the common design of display area 101 of display panel 10, the area of pixels is approximately 45%-55% of the area of the display area, that is, the aperture ratio of display area 101 is between 45% and 55%. In order to make the aperture ratio of display area 101 be equal to the aperture ratio of edge area 102, the aperture ratio of edge area 102 also needs to be designed to be in a range of 45%-55%. The width of the light-transmitting region of the present disclosure is between four-fifths to six-fifths of the width of the metal wire, which can realize that the area of the light-transmitting region is 45%-55% of the area of edge area 102, that is, the aperture ratio of display area 101 is the same as that of edge area 102. When edge area 102 of one display panels is lapped on display area 101 of the other display panel 10, the display screen of display area 101 of each of display panels 10 may be the same as the display screen of edge area 102 of its own, so that the seamless display may be achieved for the display device formed by the lapping of display panels 10, and the display device does not have obvious border boundary when viewed at a close distance.

In this implementation, edge areas 102 of the two display panels 10 in lapping region 20 have the same width. Specifically, since edge areas 102 of the two display panels 10 have the same width, edge area 102 of one display panel 10 may be quickly and completely lapped on display area 101 of the other display panel 10 during the lapping process of display panels 10. After the lapping is completed, the lapping process may be performed only according to the size of edge area 102 of one display panel 10 due to edge areas 102 with the same size, which saves the lapping time and improves the lapping efficiency: avoids lapping misplacement of display panel 10 caused by edge areas 102 with different width at the same time.

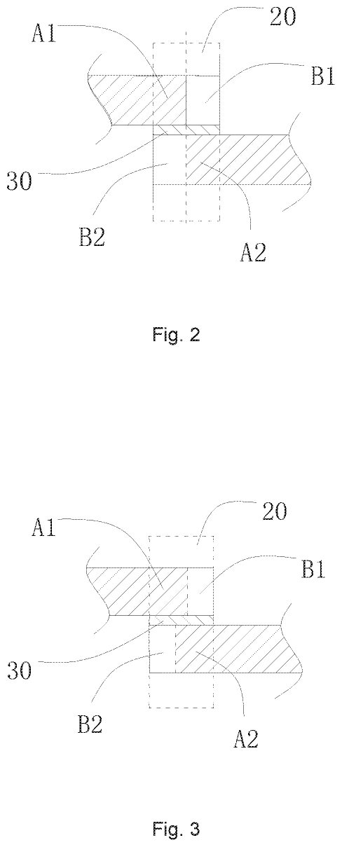

Referring to FIG. 2, the width of lapping region 20 is equal to the sum of the width of the two edge areas 102 located in lapping region 20. Specifically, one display panel 10 in lapping region 20 comprises first sub-display area A1 and first edge area B1; the other display panel 10 comprises second sub-display area A2 and second edge area B2. Since the width of lapping region 20 is equal to the sum of the width of the two edge areas 102 located in lapping region 20, the projection of first edge area B1 on second sub-display area A2 is adjacent to second edge area B2, so that there is just no overlap between first edge area B1 and second edge area B2 when the two display panels 10 are lapped with each other. There is just no overlap between first edge area B1 and second edge area B2, which not only realizes that the light passing through first edge area B1 can illuminate second sub-display area A2, and the light passing through second edge area B2 can illuminate first sub-display area A1; but also avoids that no screen display of the lapped display device caused by the overlap between first edge area B1 and second edge area B2.

Referring to FIG. 3, in other implementations, the width of lapping region 20 is greater than the sum of the width of the two edge areas 102 located in lapping region 20. Specifically; one display panel 10 in lapping region 20 comprises first sub-display area A1 and first edge area 131 the other display panel 10 comprises second sub-display area A2 and second edge area B2. Since the width of lapping region 20 is greater than the sum of the width of the two edge areas 102 located in lapping region 20, the projection of first edge area 131 on second sub-display area A2 is spaced apart from second edge area B2, so that there is no overlap between first edge area B1 and second edge area B2 when the two display panels 10 are lapped with each other. There is no overlap between first edge area B1 and second edge area B2, which not only realizes that the light passing through first edge area B1 can illuminate second sub-display area A2, and the light passing through second edge area B2 can illuminate first sub-display area A1; but also avoids that no screen display of the lapped display device caused by the overlap between first edge area B1 and second edge area B2.

The opposite surfaces of the two display panels 10 in the lapping region 20 are rough surfaces. Specifically, each of display panels 10 comprises first surface 103 and second surface 104 opposite to first surface 103; first surface 103 of one display panel 10 is opposite to second surface 104 of the other display panel, and first surface 103 and second surface 104 opposite to each other in the lapping region 20 are rough surfaces.

In the present disclosure, the display device comprises fixing portion 30 for fixing opposite surfaces of the two display panels 10 in lapping region 20. Specifically, since opposite surfaces of the two display panels 10 in lapping region 20 are rough surfaces, the friction force between fixing portion 30 and first surface 103 and second surface 104 in lapping region 20 is increased by the rough first surface 103 and rough second surface 104 opposite to each other in lapping region 20 when fixing the two display panels 10 lapped with each other by fixing portion 30, thereby improving the lapping stability of the two display panels 10.

In this implementation, fixing portion 30 is a glue layer for bonding opposite surfaces of the two display panels 10 in lapping region 20, and the glue layer is a transparent glue layer. The transparent glue layer has good optical transparency, and the transparent glue layer does not affect the transmittance of the light, so that the light can illuminate display area 101 through the transparent glue layer.

The display device comprises an anti-reflection film (not shown in Figures), and the anti-reflection film is disposed on edge area 102 of display panel 10. Specifically, the anti-reflection film is disposed on a surface of the edge area facing display area 101 in lapping region 20. Since redistribution of reflected light and transmitted light can be achieved through the anti-reflection film when light passes through edge area 102, the content of transmitted light is increased, the transmittance of light is changed, the intensity of transmitted light is increased, and the light that illuminates display area 101 is stronger. The seamless display of the display device formed by the lapping of display panels 10 can be further realized, and the display device does not have obvious border boundary when viewed at a close distance.

Still referring to FIG. 1, each of display panels 10 is provided with one polarizer 50 on both the surface facing backlight module 40 and the surface facing away from the backlight module; two polarizers 50 are disposed on display panel 10 in a misplaced way, and two polarizers 50 on the opposite surfaces of the two display panels 10 extend to the outer periphery of lapping region 20. Specifically, the two polarizers 50 are first polarizer 501 and second polarizer 502 opposite to first polarizer 501, first polarizer 501 is disposed between backlight module 40 and display panel 10, second polarizer 501 is disposed on display panel 10. That is, first polarizer 501 is disposed on first surface 103 of display panel 10, second polarizer 502 is disposed on second surface 104 of display panel 10, and first polarizer 501 extends in a direction toward lapping region 20 to lapping region 20, and the second polarizer 502 extends in a direction toward lapping region 20 to lapping region 20. When the two display panels 10 are lapped, the lapping of display panels 10 in lapping region 20 is not affected by first polarizer 501 and second polarizer 502; and polarizers 50 are covered on two surfaces of the lapped display panels 10.

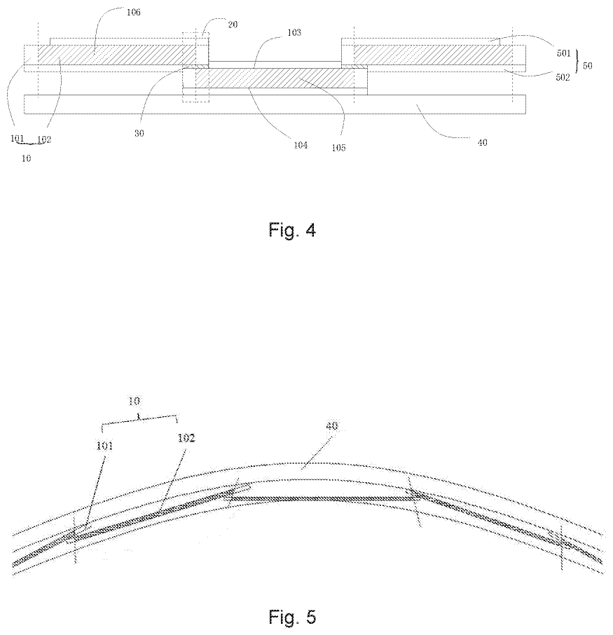

Referring to FIG. 4, the display device further comprises backlight module 40, and a plurality of display panels 10 after being lapped are disposed on backlight module 40. Specifically, backlight module 40 is provided with a backlight source, and the backlight source is used to provide a light source for display panel 10.

See FIG. 1, FIG. 4 and FIG. 5. In an implementation where a plurality of display panels are included, one of display panels 10 is lapped with two display panels 10 in edge areas 102 on the same surface, and each of the remaining display panels 10 is lapped with two display panels 10 in edge areas 102 on two opposite surfaces; the remaining display panels 10 are ones out of a plurality of the display panels except for the one which is lapped with two display panels in edge areas on the same surface. Specifically, display panel 10 located in the middle position of display device 10 is first display panel 105, and display panels located at two sides of first display panel 105 are second display panels 106; the two second display panels 106 are lapped on edge area 102 on first surface 103 of first display panel 105, and second display panels 106 located at two sides of first display panel 105 are symmetric about the central axis of first display panel 105. During the lapping of second display panels 106, edge area 102 of first surface 103 of each of second display panels 106 is lapped to one second display panel 106, edge area 102 of second surface 104 of each of second display panels 106 is lapped to the other second display panel 106. Second display panels 106 of the present disclosure are symmetric about the central axis of first display panel 105, which achieves a lapping angle according to display panels 10. The display device may be configured into a planar shape or a curved shape, and when the lapping angle of display panels 10 is 0 degrees, the display device is in a planar shape as shown in FIG. 1 and FIG. 4; when the lapping angle of display panels 10 is an acute angle; the display device is in a curved shape as shown in FIG. 5.

The above disclosure is merely preferred implementations of the present disclosure, but the disclosure is not to be construed as being limited thereto. Those skilled in the art can understand all or a portion of the process of implementing the above implementations and equivalent changes made to the implementations in accordance with the claim of the present disclosure shall be covered within the scope of the present disclosure.

What is claimed is:

1. A display device comprising a plurality of display panels, each of which includes a display area and an edge area disposed on the periphery of the display area;
any two adjacent display panels being lapped to form a lapping region; wherein the edge area of one display panel is lapped to the display area of the other display panel in the lapping region, and the edge area of one display panel is projected on the side of the edge area of the other display panel;
each of the edge areas is light transmissive to allow light to illuminate the display area through the edge area.

2. The display device as claimed in claim 1, wherein the edge area is provided with metal wires and a driving device, and a light-transmitting region used for light transmission is disposed between the metal wires, and between the metal wires and the driving device.

3. The display device as claimed in claim 1, wherein the aperture ratio of the display area is the same as that of the edge area.

4. The display device as claimed in claim 2, wherein the width of the light-transmitting region is between four-fifths to six-fifths of the width of the metal wire.

5. The display device as claimed in claim 1, wherein the display device comprises a fixing portion for fixing opposite surfaces of the two display panels in the lapping region.

6. The display device as claimed in claim 1, wherein the edge areas of the two display panels in the lapping region have the same width.

7. The display device as claimed in claim 6, wherein the width of the lapping region is equal to the sum of the width of the two edge areas located in the lapping region.

8. The display device as claimed in claim 6, wherein the width of the lapping region is greater than the sum of the width of the two edge areas located in the lapping region.

9. The display device as claimed in claim 1, wherein the display device comprises an anti-reflection film disposed on an edge area of the display panel.

10. The display device as claimed in claim 9, wherein the anti-reflection film is disposed on a surface of the edge area facing the display area in the lapping region.

11. The display device as claimed in claim 1, wherein one of the display panels is lapped with two display panels in edge areas on the same surface, and each of the remaining display panels is lapped with two display panels in edge areas on two opposite surfaces; the remaining display panels are ones out of a plurality of the display panels except for the one which is lapped with two display panels in edge areas on the same surface.

12. The display device as claimed in claim 11, wherein the angle formed by the lapping is 0 degree, and the display device is in a planar shape.

13. The display device as claimed in claim 11, wherein the angle formed by the lapping is an acute angle, and the display device is in a curved shape.

14. The display device as claimed in claim 5, wherein the fixing portion comprises a glue layer for bonding opposite surfaces of the two display panels in the lapping region.

15. The display device as claimed in claim 14, wherein the opposite surfaces of the two display panels in the lapping region are rough surfaces.

16. The display device as claimed in claim 14, wherein the glue layer is a transparent glue layer.

17. The display device as claimed in claim 1, wherein the display device further comprises a backlight module, and a plurality of the display panels are disposed on the backlight module after being lapped.

18. The display device as claimed in claim 17, wherein the backlight module is provided with a backlight source, and the backlight source is used to provide a light source for the display panel.

19. The display device as claimed in claim 17, wherein each of the display panels are provided with one polarizer on both the surface facing the backlight module and the surface facing away from the backlight module; the two polarizers are disposed on the display panel in a misplaced way, and the two polarizers on the opposite surfaces of the two display panels extend to the outer periphery of the lapping region.
